(19) United States
(12) Patent Application Publication
(10) Pub. No.: US 2025/0144899 A1
(43) Pub. Date: May 8, 2025

(54) METHOD FOR MANUFACTURING A SPECTACLE LENS

(71) Applicant: ESSILOR INTERNATIONAL, CHARENTON-LE-PONT (FR)

(72) Inventor: Pascal SOAVE, Longecourt en Plaine (FR)

(21) Appl. No.: 18/730,218

(22) PCT Filed: Feb. 10, 2023
(86) PCT No.: PCT/EP2023/053388

§ 371 Date: Jul. 18, 2024

(30) Foreign Application Priority Data
Feb. 14, 2022 (EP) 22305164.0

(51) Int. Cl. B29D 11/00

(52) U.S. Cl. CPC B29D 11/00365; B29D 11/0048

(57) ABSTRACT

The invention relates to a method for manufacturing a spectacle lens including a base portion and a plurality of solid optical elements (20) that have refraction properties distinct from those of the base portion and that are embedded in the base portion, comprising:—a step of providing said solid optical elements and a first part (11) of said base portion,—a step of arranging said solid optical elements (20) on the inner face of a first part of said base portion, and—a step of manufacturing a second part of said base portion onto said inner face and said solid optical elements to obtain said spectacle lens.

### TECHNICAL FIELD OF THE INVENTION

The present invention generally relates to the field of eyeglasses.

It more particularly relates to a method for manufacturing a spectacle lens including a base portion and a plurality of optical elements that have refraction properties distinct from those of the base portion and that are embedded in the base portion.

### BACKGROUND INFORMATION AND PRIOR ART

Myopia is characterized by the fact that the eye focuses distant objects (in far vision conditions) in front of its retina, at a non-null distance of it. Myopia is usually corrected using a concave lens.

It has been observed that the eyes of some individuals (especially those of children) corrected using such lenses focus inaccurately when observing an object located at a short distance away (in near vision conditions).

Because of this focusing defect, the image of the object is formed behind the individual's retina. Such focusing defect may have an impact on the progression of myopia of such individuals. Therefore, it is observed for most of said individuals that the myopia defect tends to increase over time.

Moreover, myopia has increased worldwide during recent years and is becoming a serious public problem. For instance, in East Asia, the prevalence can reach 80% of the population.

In this context, many techniques have been developed, to stop or slow down the evolution of myopia. Among these techniques, several strategies based on special corrective eyeglasses have been reported as effective.

For instance, document EP3730997 teaches a lens comprising a main body having a standard refraction power (based on the individuals' prescription) and a plurality of micro-lenses having an optical function of not focusing an image on the retina of the eye so as to slow down the progression of myopia.

These micro-lenses are encapsuled into the main body.

To this end, a first part of this main body is molded. Then, a resin material is dropped using a dispenser at a plurality of predetermined positions on the main body. After the resin material is cured to create said micro-lenses, the second part of the main body is molded onto the micro-lenses.

The major drawback of this solution is that it is difficult to create micro-lenses having the exact required properties.

### SUMMARY OF THE INVENTION

In this context, the present invention provides a new solution to manufacture the lens.

More specifically, the invention is directed to a method for manufacturing a spectacle lens including a base portion and a plurality of solid optical elements that have refraction properties distinct from those of the base portion and that are embedded in the base portion, comprising:
a step of providing said solid optical elements and a first part of said base portion,
a step of arranging said solid optical elements on an inner face of the first part of said base portion, and
a step of manufacturing a second part of said base portion onto said inner face of the first part of the base portion and said solid optical elements to obtain said spectacle lens.

Thanks to the invention, the solid (i.e. not liquid) optical elements can be manufactured on their side, at a distance from the base portion. Consequently, it is possible to shape these optical elements so that they present the exact required optical properties. Therefore, the obtained spectacle lens is manufactured as accurately as possible to stop or slow down the progression of myopia. Other preferred features of the invention are the following ones:
at least two of said solid optical elements present distinct refraction properties,
at least one of said solid optical elements present a non-null cylindric refractive power,
the step of arranging comprises gluing the solid optical elements onto the inner face of the first part of said base portion, e.g. onto an annular contour of said inner face,
the gluing is done by use of a gluing material,
before the step of arranging, a gluing material (for example the one mentioned just before) is put onto the inner face of the first part of said base portion or onto a face of each solid optical element,
said gluing material is polymerizable,
said gluing material is polymerized before said step of manufacturing,
said solid optical elements are deposited onto said inner face by group of at least one solid optical element, the one after the other,
the gluing material located between the last deposited group and said inner face is polymerized before another group is deposited onto said inner face,
each group comprises only one solid optical element,
said gluing material is put on said inner face, along an annular contour,
said first part is a front part of the spectacle lens and said inner face is the rear face of said front part,
said step of manufacturing comprises the molding of the second part of said base portion, by means of a mold assembly,
said mold assembly comprises a molding shell having the same diameter as that of the first part, and a tape that is wrapped around peripheral edges of the molding shell and said first part so as to maintain said first part and the molding shell at a non-null distance from each other, the inner face of said first part being oriented toward said molding shell,
the method comprises, after said step of manufacturing, a step of detaching the spectacle lens from the mold assembly,
before said step of providing, said first part is molded,
before said step of providing, said solid optical elements are molded.

### DETAILED DESCRIPTION OF EXAMPLE(S)

The following description with reference to the accompanying drawings, given by way of non-limiting example makes it clear what the invention consists in and how it can be reduced to practice.

In the accompanying drawings:

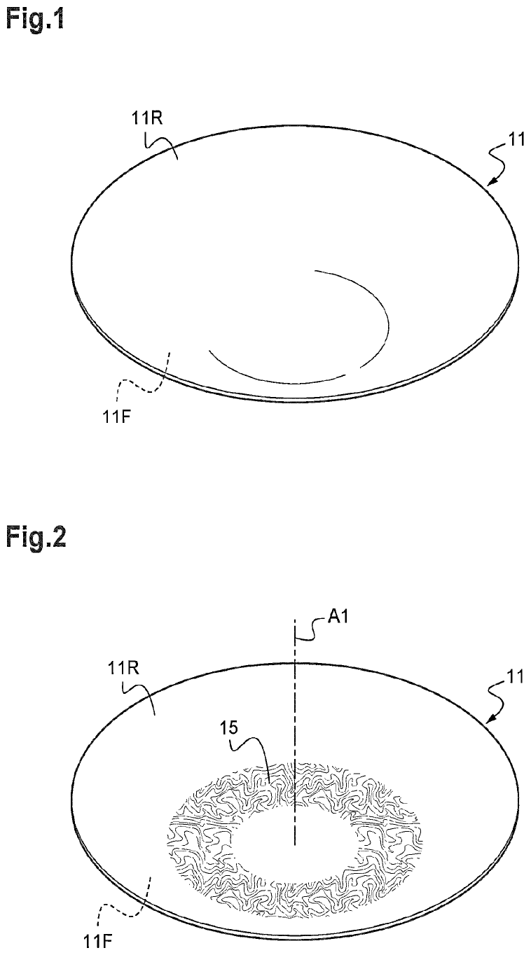

FIG. 1 is a schematic view of a first part of an ophthalmic lens at a first step of a manufacturing process according to the invention,

FIG. 2 is a schematic view of the first part of the ophthalmic lens at a second step of its manufacturing process,

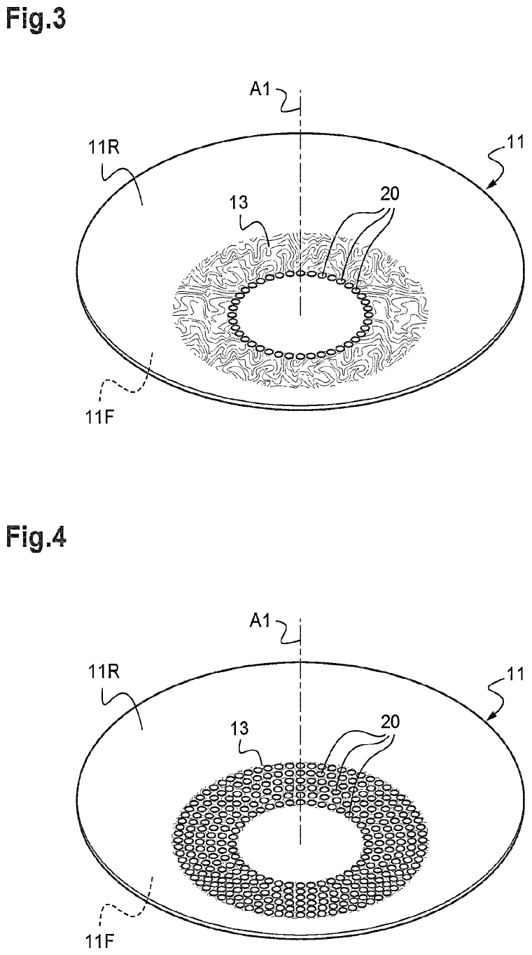

FIGS. 3 and 4 are schematic views of the first part of the ophthalmic lens at a third step of its manufacturing process, while it receives micro-lenses,

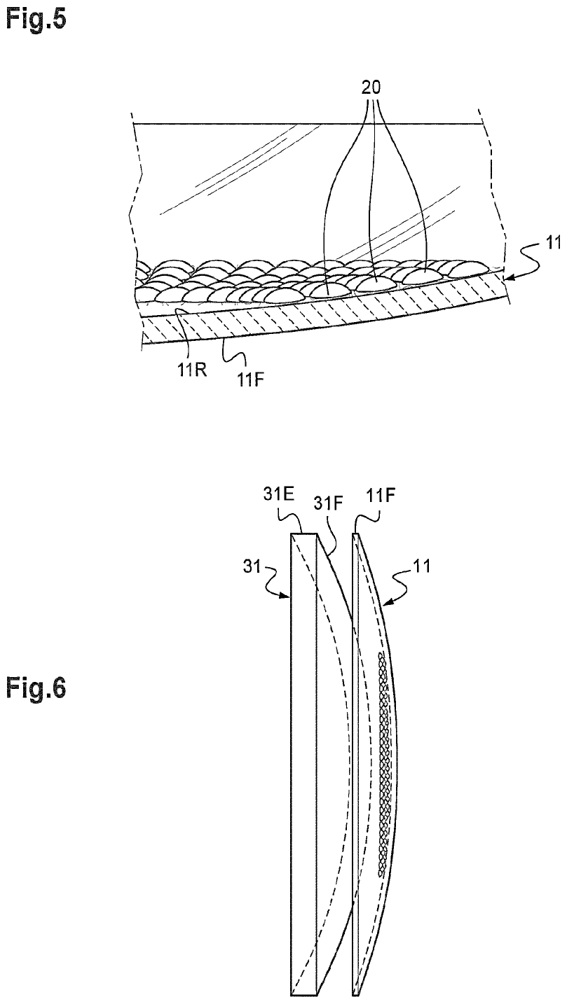

FIG. 5 is a partial cross-sectional view of the first part of the ophthalmic lens shown in FIG. 4,

FIG. 6 is a side view of the first part of the ophthalmic lens shown in FIG. 4 and of a molding shell,

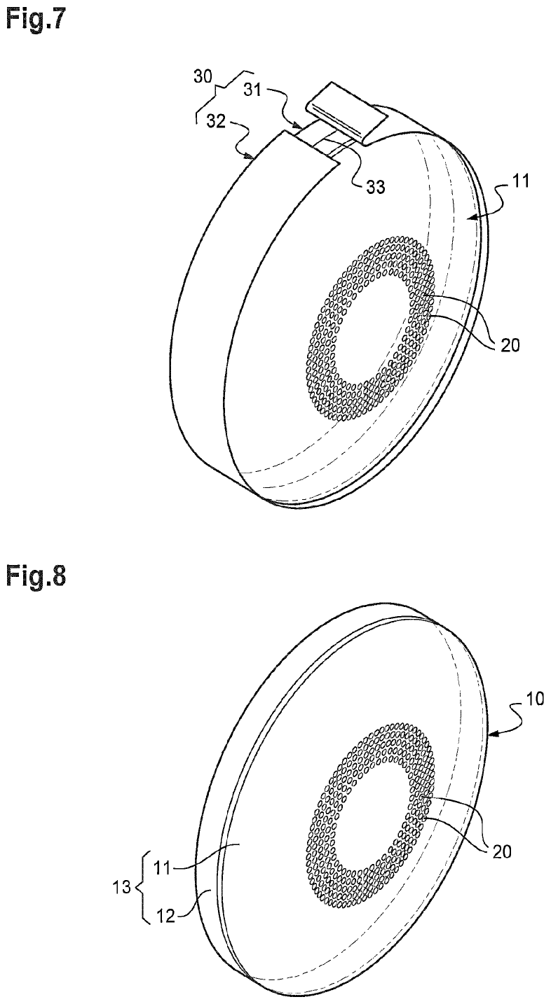

FIG. 7 is a schematic view of the mold assembly used to manufacture the ophthalmic lend, and

FIG. 8 is a schematic view of the ophthalmic lens at a final step of its manufacturing process.

The invention relates to a spectacle lens, here an ophthalmic lens that is designed to be cut-out in order to be mounted into a frame, so as to be worn in front of an eye of an individual (called hereafter “the wearer”).

In the context of the present invention, the term “lens” preferably refers to an uncut optical lens. This uncut optical lens is not necessarily finished in the sense in that it can still be covered by finishing layers (antifog coating, anti-reflective coating . . . ).

In the remainder of the description, the terms «front »and «rear »are used and are to be understood in the wearing conditions of the lens. In other words, while the lens is worn, the rear of an element is directed toward the corresponding eye of the wearer and the front is directed in the opposite direction.

In the following, the description will deal with refractive power or correcting power.

Such an optical power of a correcting ophthalmic lens (or of a part of it) is defined by its spherical, cylindrical, and prismatic refringence properties. It will be understood that such an optical definition is of a scope that is more general than a definition of surfaces only: it defines the overall refringence effect of the lens (or of a part of it) on an incident light ray, which results from the algebraic sum of the refringences imparted successively by both the front and the rear faces of the lens.

Among these refringence properties, the first to be defined is the “spherical refringence” power of a lens for an incident beam passing through the lens. It is defined as the magnitude that characterizes and quantifies the primary effect of spherical refringence (“magnifying glass” effect) of the lens on the beam under consideration: if it is positive, the lens has a converging effect on the beam; if it is negative, the effect on the beam is diverging. The point of the lens where the magnifying glass effect is zero (i.e., for a lens having optical power that is purely spherical, the point where the incident ray and the transmitted ray have the same axis) is known as the optical center. The axis that is normal to the front face of the lens and that passes through this point is called the main axis A1.

The term “cylindrical refringence power” of a lens is defined, for an incident ray passing through the lens (also known as the cylindrical optical power), as being the magnitude that characterizes and quantifies the cylindrical refringence effect exerted by the lens on the ray under consideration, whereby not one but two focal areas are formed that are situated in different planes, which focal areas are generally mutually perpendicular and referred to as the tangential focus and the sagittal focus. This cylindrical power, also known as “astigmatism power” or merely as “astigmatism”, corresponds to the difference between the spherical powers associated with the two focal areas. The two areas are identified by an axis passing through their “optical centers” and commonly referred to as the cylinder axis.

Finally, the “prismatic refringence power” of a lens is defined, for an incident ray passing through the lens (also known as the prismatic optical power), as being the magnitude that characterizes and quantifies the prismatic refringence effect, or more simply the deflection exerted by the lens on the ray under consideration. This prismatic power, also known as “prism”, corresponds to the angle through which the ray is deflected, i.e. the angle formed between the entry and exit portions of the ray. The prism is made up of two components: a horizontal component referred to as the “horizontal prism” corresponding to the angle formed between the protrusions of the incoming and outgoing portions of the ray onto a horizontal plane, and a vertical component, referred to as the “vertical prism” corresponding to the angle formed between the protrusions of the incoming and outgoing portions of the ray onto a vertical plane.

The following description will be divided in two parts. First, the ophthalmic lens to be manufactured will be described. Then, the process for manufacturing this lens will be explained.

The ophthalmic lens 10 to be manufactured is represented in FIG. 8. Here, this lens is specifically designed to modify the natural evolution of an optical deficiency, for instance myopia.

This ophthalmic lens 10 includes a first optical refraction area for providing correct vision to the wearer at a determined distance, and a second optical refraction area for changing the natural evolution of the optical deficiency.

The first optical refraction area is centered in the lens, and the second one is located all around the first one.

The first optical refraction consists, for instance, in a spherical power for providing correct far vision to the wearer (for looking at objects situated at more than 6 meters). This first optical refraction can also include a cylindrical and/or a prismatic power.

The second optical refraction provides an additional optical feature. This refraction is specifically designed to prevent or to limit or to stop the evolution of myopia.

To this end, the used ophthalmic lens 10 contains a plurality of solid optical elements in the shape of lenslets, that are embedded in the remainder of the ophthalmic lens 10 (named hereinafter the base portion 13).

It may be noted that different models of lenslets can be used: spherical, aspherical, plano-convex, bi-convex, polygonal . . .

Lenslets may each have a contour shape inscribable in a circle having a diameter greater than or equal to 0.5 micrometers (μm) and smaller than or equal to 1.5 millimeters (mm).

More particularly, lenslets may be micro-lenses.

Here, the micro-lenses 20 have an optical function of not focusing an image on the retina of the eye so as to slow down the progression of the abnormal refraction of the eye.

These structures may provide optical wave front modification in intensity, curvature, or light deviation, where the intensity of wave front is configured such that structures may be absorptive and may locally absorb wave front intensity with a range from 0% to 100%, where the curvature is configured such that the structure may locally modify wave front curvature with a range of +/−20 Diopters, and light deviation is configured such that the structure may locally scatter light with angle ranging from +/−1° to +/−30°.

Each micro-lens 20 is preferably made from a material distinct from that of the base portion 13. They are distinct in the sense in that their refractive indexes are different from each other.

All the micro-lenses 20 may be identical. In this embodiment, they all have a non-null spherical refringence power.

But in a preferred embodiment, some of the micro-lenses 20 differ from the others. Specifically, at least one of said micro-lenses present a spherical refringence power distinct from that of another one of the micro-lenses.

In a preferred embodiment, at least one of said micro-lenses present a non-null cylindric refractive power.

It may be noted that at least one of said micro-lenses can be made in a material having a refractive index distinct of that of another one of the micro-lenses.

In other words, the ophthalmic lens 10 comprises:
a transparent base portion 13 (the main body) that is designed to have a first refractive power based on a prescription for correcting an abnormal refraction of the wearer's eye, and
a plurality of transparent and solid micro-lenses 20 having optical properties distinct of that of the base portion 13.

The term “prescription” is to be understood to mean a set of optical characteristics of optical power, of astigmatism, of prismatic deviation, determined by an ophthalmologist or optometrist in order to correct the vision defects of the eye. For example, the prescription for a myopic eye comprises the values of optical power (spheric, cylindric and prismatic) with an astigmatism axis. In the following, the base portion 13 of the ophthalmic lens 10 will be considered as having only a spherical refractive power.

Such an ophthalmic lens 10 is described in more details in document WO2019166654.

The process for manufacturing the ophthalmic lens 10 can now be described in detail. It is performed in five successive steps.

During this process, the main part 13 will be manufactured in two parts 11, 12 (in practice in two layers) so as to sandwich the micro-lenses 20.

During a first step, the manufacturer order or manufacture a first part 11 of the base portion 13 and the micro-lenses 20.

Here, the first part 11 of the base portion is formed by a part of the thickness of the ophthalmic lens 10.

Here, this first part 11 is a front part of the ophthalmic lens 10. Consequently, the front face 11F of this first part 11 will form the front face of the ophthalmic lens, and its rear face 11R (or inner face) will be covered by the other part 12 of the base portion 13.

The micro-lenses 20 are solid in the sense in that, at the end of this step, they have shapes that will not change during the manufacturing of the ophthalmic lens 10, hence they can be defined as finished micro-lenses.

In a first example, the first part 11 and the micro-lenses 20 can be molded.

In our example, the micro-lenses are ordered to an external supplier and the first part 11 is molded in situ.

To this end, a molding assembly having an internal cavity that suits with the client's prescription is selected. The aim is to fill this molding assembly so as to obtain a first part 11 having a front face 11F shape and a thickness determined in function of the prescription of the wearer (see FIG. 1).

In a variant, the first part 11 can be molded so as to be a spheric plano lens, that is to say a lens having no refractive power.

The second step shown in FIG. 2 consists in applying a gluing material onto the rear face 11R of the first part 11 of the base portion 13 or onto a front face of each micro-lens 20.

Here, the used embodiment consists in covering the second optical refraction area of the rear face 11R of the first part 11 with the gluing material. This embodiment is preferred since it is easier to perform.

The gluing material is selected as being able to fasten the micro-lenses 20 to the first part 11 during the third and fourth steps of the process (that will be described hereafter).

Here, this material is polymerizable. It comprises an UV initiator, for instance of the type “CGI 1850” (with a mix of BAPO and IRGACURE® 184, for instance 50% of each).

As shown in FIG. 2, for example, this material 15 is applied on an annular area that is centered about the main axis A1. The micro-lenses 20 will be indeed distributed in this area, at a distance from the optical center of the lens (the center of the lens being used by the wearer to look at far objects).

The third step represented in FIG. 3 consists in arranging the micro-lenses 20 on the rear face 11R of the first part 11 of the base portion 13.

Each of the micro-lenses 20 present a face to be glued on the rear face 11R that is flat or convex, so as to be able to be glued on this face (that is concave). In a preferred embodiment, the radius of curvature of the front faces of the micro-lenses 20 is equal to that of the rear face 11R of the first part 11.

During this step, as shown in FIGS. 3 and 4, the micro-lenses 20 are for example first distributed along an inner circle centered on the main axis A1, then they are distributed along other circles concentric with the latter.

The micro-lenses are consequently positioned to form a network. The micro-lenses may have periodical or pseudo periodical layout, but may also have randomized positions. Other exemplary layouts for micro-lenses may be a grid with constant grid step or a honeycomb layout.

The distance between the micro-lenses may range from 0 (contiguous) to 3 times the structure (separate micro-lenses). The micro-lenses 20 form non-contiguous optical elements.

The distribution of the micro-lenses will be advantageously performed by means of a device having a support that fastens the first part 11 and a head that can move relative to the support so as to catch the micro-lenses 20 the one after the other to deposit them on the first part 11.

We can note here that the micro-lenses can differ from each other according to their position on the first part 11. For instance, the micro-lenses 20 may have different spherical powers from a circle to another.

At this step, the non-polymerized gluing material can enable the micro-lenses to remain at their location (see FIG. 5).

Then, the gluing material is polymerized.

More specifically, this material can be polymerized once several or all the micro-lenses have been deposited on the first part 11.

But in a preferred variant, the material is polymerized area by area, after each deposition of a micro-lens on the first part, on the interface between the last deposited micro-lens and the first part 11, by a short UV flash.

Here the UV flash has a power comprised between 20 and 60 mW·cm⁻².

Thanks to this polymerization, the micro-lenses 20 are permanently bonded to the first part 11 and can no longer move.

The fourth step consists in manufacturing the second part 12 of the base portion 13 onto the rear face 11R of the first part 11 and onto said micro-lenses 20 in order to obtain said ophthalmic lens 10.

This second part 12 may be manufactured by additive manufacturing. But in a preferred embodiment, the second part 12 is molded directly onto the first part 11 by means of a mold assembly 30 (see FIG. 7).

This mold assembly 30 may comprise a single molding shell 31 and a tape 32. It is indeed unnecessary to use another molding shell since the first part 11 can play the role of such a molding shell.

We can note here that the first part 11 presents to this end a peripheral edge 11E that is cylindrical (see FIG. 6).

The molding shell 31 is selected to have a cylindrical peripheral edge 31E of the same diameter than that of the first part 11 and a front face 31F that suits with the wearer's prescription.

The tape 32 is designed to be wrapped all around the peripheral edges 11E, 31E of the molding shell 31 and the first part 11 so as to maintain said first part 11 and the molding shell 31 at a non-null distance from each other (said distance being determined as a function of the prescription).

To this end, the molding shell 31 and the first part 11 are secured on respective spindles (not shown), in front of each other, at a convenient distance from each other. Then, a first extremity of the tape 32 is stuck on both peripheral edges 11E, 31E. After, the two elements (the molding shell 31 and the first part 11) are rotatably driven about their main axes A1 so that the tape 32 wraps around these peripheral edges 11E, 31E.

The rotation is stopped before the two elements have made a complete revolution. Consequently, at this step, as shown in FIG. 7, only a main part of the tape 32 is stuck on these elements. The remainder is maintained at a distance from these elements in order to leave an opening 33 open.

Then, the molding cavity defined between the two elements is filled with monomer. We can note that the resin material (monomer) for forming the second part 12 is substantially the same as that used for molding the first part 11 (it is therefore distinct from the one used to make the micro-lenses).

Then, the remainder of the tape 32 is pushed against the peripheral edges 11E, 31E of the two elements to close the opening 33. At this step, the molding cavity is sealed and the molding assembly 30 can be placed in a polymerization unit so as to generate the ophthalmic lens 10.

The fifth and last step consists then in detaching the ophthalmic lens 10 from the mold assembly 30.

To this end, when the lens is polymerized, the tape 32 is pelt off and the molding shell 31 is separated from the remainder, which forms the molded ophthalmic lens 10.

At this step, the micro-lenses 20 are entirely embedded into the base portion 13, so that the ophthalmic lens 10 has front and rear faces that are smooth without bump or depression.

The present invention is in no way limited to the embodiment described and shown.

In particular, the micro-lenses may be stuck onto the rear part 12 of the base portion 13, and the front part 11 may be molded onto this rear part 12.

1. Method for manufacturing a spectacle lens including a base portion and a plurality of solid optical elements that have refraction properties distinct from those of the base portion and that are embedded in the base portion, comprising:
a step of providing said solid optical elements and a first part of said base portion,
a step of arranging said solid optical elements on an inner face of the first part of said base portion, and
a step of manufacturing a second part of said base portion onto said inner face of the first part of the base portion and said solid optical elements to obtain said spectacle lens.

2. Method according to claim 1, wherein at least two of said solid optical elements present distinct refraction properties.

3. Method according to claim 1, wherein at least one of said solid optical elements present a non-null cylindric refractive power.

4. Method according to claim 1, wherein the step of arranging comprises gluing the solid optical elements onto the inner face of the first part of said base portion.

5. Method according to claim 1, wherein, before the step of arranging, a gluing material is put onto the inner face of the first part of said base portion or onto a face of each solid optical element.

6. Method according to claim 5, wherein said gluing material is polymerizable.

7. Method according to claim 6, wherein said gluing material is polymerized before said step of manufacturing.

8. Method according to claim 7, wherein said solid optical elements are deposited onto said inner face by group of at least one solid optical element, the one after the other, and wherein the gluing material located between the last deposited group and said inner face is polymerized before another group is deposited onto said inner face.

9. Method according to claim 5, wherein said gluing material is put on said inner face, along an annular contour.

10. Method according to claim 1, wherein said first part is a front part of the spectacle lens and said inner face is the rear face of said front part.

11. Method according to claim 1, wherein said step of manufacturing comprises the molding of the second part of said base portion, by means of a mold assembly.

12. Method according to claim 11, wherein said mold assembly comprises a molding shell having the same diameter as that of the first part, and a tape that is wrapped around peripheral edges of the molding shell and said first part so as to maintain said first part and the molding shell at a non-null distance from each other, the inner face of said first part being oriented toward said molding shell.

13. Method according to claim 11, comprising, after said step of manufacturing, a step of detaching the spectacle lens from the mold assembly.

14. Method according to claim 1, wherein before said step of providing, said first part is molded.

15. Method according to claim 1, wherein before said step of providing, said solid optical elements are molded.
